(19) United States
(12) Patent Application Publication
(10) Pub. No.: US 2006/0109755 A1
(43) Pub. Date: May 25, 2006

(54) System, method and apparatus for searching for and automatically recording broadcast programmes

(76) Inventors: Johannis Friso Rendert Blacquiere, Eindhoven (NL); Alphonsus Tarcisius Jozef Maria Schipper, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/538,336

(22) PCT Filed: Nov. 14, 2003
(86) PCT No.: PCT/IB03/05217

§ 371 Date: Jun. 10, 2005

(30) Foreign Application Priority Data
Dec. 13, 2002 (EP) 02080273.2

(51) Int. Cl. G11B 21/08

(52) U.S. Cl. 369/30.03

(57) ABSTRACT

A system comprises a recordable medium (50) and a recording apparatus for recording programs on the recordable medium (50). The recordable medium (50) comprises a recorded search instruction (51). The recording apparatus comprises a receiver (10) which is able to receive receivable programs (IS), and a comparator (30) which compares the recorded search instruction (51) with program information (IRP) on the receivable programs (IS) to record a particular one of the receivable programs (IS) on the recordable medium (50) only if the particular one of the receivable programs (IS) matches the recorded search instruction (51).

The invention relates to a system of a recordable medium and a recording apparatus for recording programs on the recordable medium, a recording apparatus for use in such a system, a recordable medium for use in such a system, and a method of recording.

The invention is particular relevant to a DVD-recorder.

U.S. Pat. No. 6,243,353 discloses an optical disc which may be dedicated to recording a specific program. The recording reservation information necessary to perform the recording reservation comprises a variety of pieces of information, e.g., the program name, the recording period, the recording time, week information, and channel information. The recording reservation information is written on the optical disc. This is a quite inflexible approach, the specific program will only be recorded at a daily or a weekly rate during the time period indicated and received at the channel indicated. This prior art approach does not allow the user to record a specific program independent on when it is transmitted and on which channel or via which medium it is transmitted, unless the user provides a large amount of recording reservation information taking into account all the channels on which the specific program is available and taking into account the respective times the specific program is available on each of these channels.

It is an object of the invention to provide a recorder which requires the user to provide less recording reservation information to record a specific program type on a recording medium dedicated to record this specific program type.

A first aspect of the invention provides a system of a recordable medium and a recording apparatus as claimed in claim 1. A second aspect of the invention provides a recording apparatus as claimed in claim 3. A third aspect of the invention provides a recordable medium as claimed in claim 12. A fourth aspect of the invention provides a method of recording as claimed in claim 16. Advantageous embodiments are defined in the dependent claims.

The system in accordance with the invention comprises a recordable medium and a recording apparatus.

A search instruction is recorded on the recordable medium.

The recording apparatus comprises a receiver which is able to receive a plurality of programs. Usually, the receiver will be able to receive one of the plurality of programs at a time. The receivable programs are all the programs or a subset of all the programs which the receiver is able to receive. For example, when the programs are TV-broadcasts which are modulated on high frequent carriers to form a high frequency band of TV-channels, the receivable programs are the programs available at the channels which the receiver is able to receive. Even, although usually the receiver is able to receive one of the TV-channels at a time, as another example, the plurality of programs may also be comprised in a digital data stream. The data stream may provide different programs at a high rate serially in time, or as short interleaving packets.

The recording apparatus further comprises a comparator which compares program information on the receivable programs with the search instruction recorded on the recordable medium. For example, the receiver checks the receivable programs on the search criteria one by one by selecting the TV channels cyclical and retrieving program information for each selected TV channel. In another example, the program information on the receivable channels is present on a specific TV channel, or in the data stream.

If the comparator detects that the program information of a particular program matches the search criteria recorded on the recordable medium in the recording apparatus, this particular program will be recorded on the recordable medium. Programs of which the program information does not match the search criteria will not be recorded on the recordable medium.

In an embodiment as defined in claim 2, the recordable medium comprises a recorded indication of a specific type of program which should be recorded on this particular recordable medium. The comparator detects whether one of the receivable programs matches the specific type of program which should be recorded. The comparator controls the recording unit to record one of the receivable programs on the recording medium only if it matches the specific type of program which should be recorded.

For example only, to elucidate the operation of the embodiment of the system in accordance with claim 2, it is assumed that the recording apparatus is a DVD-recorder which has a tuner for receiving TV-broadcast programs. First the user has to insert a recordable or re-writable DVD-disc on which a search criterion is recorded. For example, this disc is labeled by the user as a news disc. The recorded information on the disc only indicates that the type of program to be recorded is news. Thus, there is no information on the disk about the time or channel the program occurs. The recorder will have to search whether the type of the program to be recorded is available in the receivable programs. For example by checking teletext (widespread in Europe, also know as close caption in the USA, and further referred to as TXT) information. The program information may also be available as program specific information in DVB, Gemstar program information, Nextview, or the extended data services of close captioning.

The recorder will automatically record all programs which are detected to be of the specific type, in this case news, independent on the channel or time the program occurs. The user has to perform a minimum amount of effort to obtain a maximum flexibility in recording a specific type of information. Further, the management of the record mediums is very simple as this particular record medium can be labeled with a fixed label indicating the specific type of program.

U.S. Pat. No. 6,212,327 discloses a computer which receives an information stream which may comprise the current contents of selected TV channels. The computer may be instructed by a user to have programs recorded whose description in the information stream contains keywords such as “Cary Granf” or “basket-ball”. The computer searches for these user-selected keywords in the data stream. If such a keyword is found, the computer formulates instructions for controlling the record/playback device to record a program associated with the key data item. Then the computer waits until the start time of the associated program to send an IR command to the separately arranged record/playback device to start recording the program. When the program end time is reached, the computer sends an IR command to the record/playback device to stop the recording. The computer may obtain the program data from a data stream originating from a server or from a computer readable medium on which this data is recorded.

This prior art does not address the management of the record medium to be present in the record/playback device. As the record medium has no recorded information on the type of program to be recorded, a high discipline of the user is required to have the correct record medium inserted in the record/playback device. If a specific program is recorded, the user should easily be able to identify that on this particular disc the specific program is recorded. This is especially important if the record medium is a rewritable medium on which successively many programs can be recorded. Further, the user should check whether sufficient free space should be available on the disc inserted. Otherwise another type of program may be deleted to enable the recording of the specific type of program.

The optical disc disclosed in U.S. Pat. No. 6,243,353 comprises recording reservation information which is a complete set of information (program name, time, date, channel) required by the recorder to be able to record a specific program. The data on the optical disc is not a search instruction but a record command. The recorder will not search for programs matching the search instruction but simply record the program as commanded by the record command.

In an embodiment as defined in claim 5, the program data available in specific TXT pages is used. This has the advantage that the information on the receivable programs can be easily extracted from the programs received without the need for extra connections such as via internet or by phone to get the information on the type of programs available on which channel at what time.

In an embodiment as defined in claim 6, the recordable medium is a re-writable medium. If insufficient free space is available, the oldest recorded program(s) are over-written to make sufficient space for the latest program to be recorded. Usually, this is not a problem because this particular recordable medium is dedicated to one particular program only. The user will not lose not related programs, and it is very likely that he has consumed the oldest recorded program(s) already, or is interested in the latest program only.

In an embodiment as defined in claim 11, the recording apparatus comprises a further recordable medium which may be a hard-disc, a solid state memory, a tape or any other medium suitable to record programs. The removable recordable medium can be used to record on the recordable medium the programs as indicated by the search instruction, both as available on the further recordable medium and as available in the programs received. In this manner, also the particular programs matching the search instruction which programs are already recorded on the further recordable medium will be recorded on the removable medium. Such a removable medium enables to transport the recorded programs of the particular type to other locations.

In an embodiment as defined in claim 12, the recordable medium is provided with a visible marking indicating the search instruction recorded on the recordable medium. This allows selling recordable mediums which are marked in accordance with the information which will be recorded on the recordable medium. It is especially interesting to sell a set of recordable mediums, each one for recording another type of program, and each being visually marked according the type of program to be recorded. For example, such a set may comprise recordable mediums for news, weather, football, sports in general, a particular soap series.

Preferably, the visually marking comprises an image representing the type of program.

The user now has an extremely simple way of managing his recordings. The user simple inserts the recordable medium marked with the type of program of interest and the recording apparatus will record this type of program as long as this recordable medium is inserted in the recording apparatus.

If the user inserts a record-once medium, the user has to insert another recording medium of the same type when the recording medium presently inserted has insufficient free space. Preferably, the recorder warns the user if this is the case.

If the user inserts a re-writable medium, the user may indicate whether it is allowed to overwrite earlier recorded programs or not. If not, the same procedure may be followed as for record-once mediums. If yes, the disc will automatically write over older recorded programs and thus will contain the programs of the specified type which are received the latest. Usually, this suffices the needs of the user, which has already consumed the older recorded programs.

These and other aspects of the invention are apparent from and will be elucidated with reference to the embodiments described hereinafter.

In the drawings:

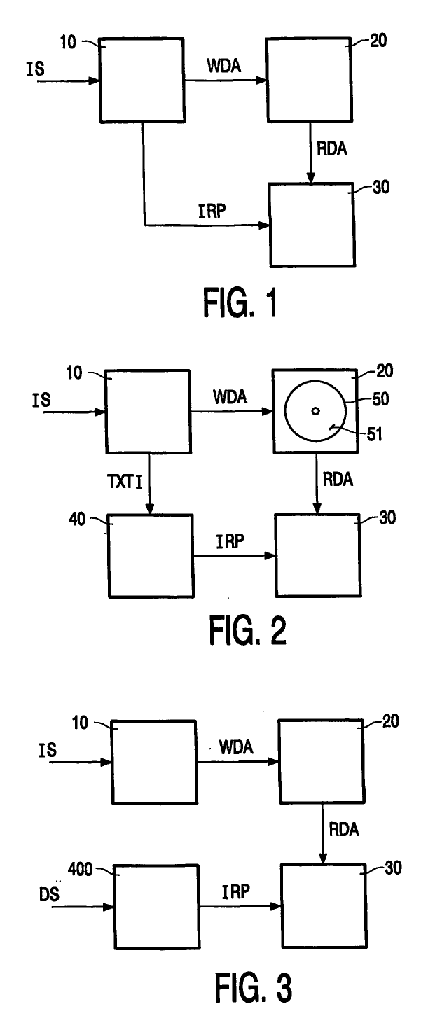

FIG. 1 shows a block diagram of an embodiment of the recording apparatus in accordance with the invention,

FIG. 2 shows a block diagram of an embodiment of the recording apparatus in accordance with the invention,

FIG. 3 shows a block diagram of an embodiment of the recording apparatus in accordance with the invention,

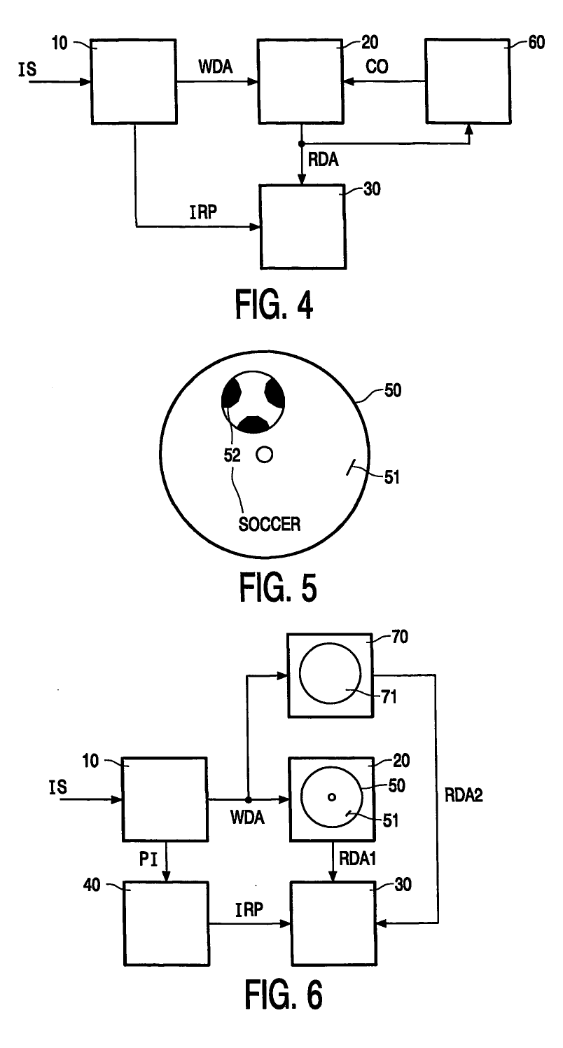

FIG. 4 shows a block diagram of an embodiment of the recording apparatus in accordance with the invention,

FIG. 5 shows an optical disc provided with a text and image label corresponding to the search criterion recorded on the optical disc, and

FIG. 6 shows a block diagram of an embodiment of the recording apparatus in accordance with an embodiment of the invention in which a further recordable medium is present.

The same references in different Figs. refer to the same signals or to the same elements performing the same function.

FIG. 1 shows a block diagram of an embodiment of the recording apparatus in accordance with the invention. The recording apparatus comprises a receiver 10, a recording unit 20, and a comparator or detector 30.

The receiver 10 has an input for receiving an input signal IS in which the receivable programs are present and an output at which the data WDA is available for recording on a recorder unit 20. If the input signal IS comprises a high frequent television band as available from an antenna (terrestrial or satellite) or in a cable system, the receiver 10 comprises a tuner for retrieving a desired program at a particular channel in the band. The input signal IS may also be a data stream as available on internet, and for example generated by a particular server. The receiver 10 supplies information on the receivable programs IRP. In the embodiment of the invention shown in FIG. 1, this information is retrieved from the input signal IS directly or via the tuner. In the first situation, extra information may be present in the input signal IS indicating all the programs available in the input signal IS. For example, a special broadcast channel may be used to convey this information. A dedicated tuner may retrieve this information. It is also possible to control the already present tuner to cycle through all the channels available to check for the type of programs available.

The recorder unit 20 reads from the recording medium the recorded information RDA which indicates which type of program should be recorded on this particular recording medium present in the recorder apparatus.

The detector 30 receives the recorded information RDA and the information on the receivable programs IRP and checks whether one of the receivable programs matches the type of program which should be recorded. If yes, the program will be recorded on the recordable medium. If no, the program will not be recorded.

For example, the specific type of program may be indicated as “news”, “soccer”, or a more specific name, for example, of a specific soap series.

FIG. 2 shows a block diagram of an embodiment of the recording apparatus in accordance with the invention. This embodiment of the recording apparatus differs from the embodiment of FIG. 1 in that the recording apparatus further comprises an information receiver 40, and in that the recording unit 20 is an optical drive in which an optical disc 50 can be inserted On the optical disc 50, information 51 is recorded indicating the specific type of program which should be recorded on this disc 50.

The information receiver 40 retrieves information on the type of programs available in the input signal IS, for example by using teletext information TXTI. A tuner of the receiver 10 is controlled to receive a special channel on which the TXT information TXTI of all the channels which can be received is present. This TXT information TXTI may already be in the correct format indicating the type of programs available at which channel at which time. Or, the tuner of the receiver 10 is controlled to scan through all the channels which can be received to check the TXT information TXTI already present at the channel for information on the type of programs available and for the time at which the program will be available. The retrieval of the timing information may be performed selectively, only when the type of program detected matches the specific type of program as indicated on the recordable medium 50.

FIG. 3 shows a block diagram of an embodiment of the recording apparatus in accordance with the invention. FIG. 3 differs from FIG. 2 in that the information receiver 40 is replaced by the information receiver 400 which receives the information about which programs are available when (and if applicable at what channel) from a separate data stream DS. The separate data stream DS may be generated by a server via internet or via phone.

FIG. 4 shows a block diagram of an embodiment of the recording apparatus in accordance with the invention. FIG. 4 differs from FIG. 1 in that the recording apparatus further comprises a controller 60 which checks whether a still free space on the recordable medium 50 is sufficient to record the receivable program matching the specific type of program 51. The controller 60 supplies control signal CO to the recorder unit 20 to manage the files on the recording medium 50. The program which matches is recorded in the free space if sufficient. Or, the program matching is recorded over at least one already recorded program. It is also possible to delete only a part of an earlier recorded program.

FIG. 5 shows an optical disc 50 provided with a text and image label 52 corresponding to the search criteria 51 recorded on the optical disc 50.

FIG. 6 shows a block diagram of an embodiment of the recording apparatus in accordance with an embodiment of the invention in which a further recordable medium 71 is present. This embodiment of the recording apparatus differs from the embodiment of FIG. 2 in that the recording apparatus further comprises a further recording unit 70 which is able to record programs on a further recordable medium 71. The further recording unit 71 receives the data WDA and supplies the recorded information RDA2 to the detector 30. The recording unit 50 supplies the recorded information RDA1 to the detector 30.

Usually, this further recording unit 70 uses a non-removable recording medium, and, usually, is able to record a significant amount of programs. The further recording unit 70 is for example, a hard disk, a tape recorder, or an optical drive which stores the information on an optical disc. Such a recording apparatus is particular interesting for storing video programs such as for example TV broadcasts.

A further difference with respect to FIG. 2 is that the information receiver 40 retrieves the program information out of the input signal IS based on available information PI which may differ from the teletext information TXTI.

It should be noted that the above-mentioned embodiments illustrate rather than limit the invention, and that those skilled in the art will be able to design many alternative embodiments without departing from the scope of the appended claims.

Although with respect to the figures, on the recordable medium an indication is recorded for the type of program which should be recorded on this particular recordable medium, in a more general embodiment, another search criterion may be recorded. The recording apparatus will then search for receivable programs which match this search criterion.

The search criterion may also be something different than the indication of a program type, such as for example, all programs is which a specific color is present or dominant, or a program which contains music.

The search criterion may be a Boolean function of several criteria.

The search for receivable programs matching the search criterion may be instantaneous in the sense that the programs are continuously searched and at the instant a matching program is found it will be recorded. It is also possible that the program information comprises besides the type of program the future time the program starts and ends. The recording apparatus may store the timing information for matching programs and start the program at that future instant.

The program may be recorded without or with data compression. Preferably, data compression is used, which for video programs may be based on one of the MPEG standards.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A system of a recordable medium and a recording apparatus for recording programs on the recordable medium, the recordable medium comprises a recorded search instruction, and the recording apparatus comprises:
a receiver for receiving receivable programs,
a comparator for comparing the recorded search instruction with program information on the receivable programs to record a particular one of the receivable programs on the recordable medium only if the particular one of the receivable programs matches the recorded search instruction.

2. A system as claimed in claim 1, wherein the recorded search instruction comprises an indication of a specific type of program to be recorded on the recordable medium.

3. A recording apparatus for use in a system as claimed in claim 1, the recording apparatus comprises:
a receiver for receiving receivable programs,
a comparator for comparing the search instruction recorded on the recordable medium with program information on the receivable programs to record a particular one of the receivable programs on the recordable medium only if the particular one of the receivable programs matches the recorded search instruction.

4. A recording apparatus as claimed in claim 3, wherein the recorded search instruction comprises an indication of a specific type of program to be recorded on the recordable medium.

5. A recording apparatus as claimed in claim 4, further comprising an information receiver for receiving the program information indicating a type and times of occurrence of the receivable programs to supply the program information to the comparator.

6. A recording apparatus as claimed in claim 5, wherein the information receiver comprises a teletext receiver for scanning teletext pages containing the program information.

7. A recording apparatus as claimed in claim 3, further comprising a controller for checking whether a still free space on the recordable medium is sufficient to record the receivable program matching the specific type of program, to record the program matching in the free space, if sufficient, or to delete at least one already recorded program to free sufficient space to record the program matching.

8. A recording apparatus as claimed in claim 7, wherein the at least one already recorded program comprises a recorded program recorded earliest.

9. A recording apparatus as claimed in claim 3, wherein the recording apparatus is a recorder for recording programs on an optical medium, and wherein the programs are TV-broadcast programs.

10. A recording apparatus as claimed in claim 3, wherein the recording apparatus is a DVD-recorder.

11. A recording apparatus as claimed in claim 1, wherein
the recordable medium is a removable recordable medium,
the recording apparatus further comprises a further storage medium, and
the comparator is adapted for further comparing the recorded search instruction with program information on programs recorded on the further storage medium, to record on the recordable medium a particular one of the programs recorded only if the particular one of the programs recorded matches the recorded search instruction.

12. A recordable medium for use in the system of claim 1, the recordable medium comprising the recorded search instruction.

13. A recordable medium as claimed in claim 12, wherein the recorded search instruction comprises an indication of a specific type of program to be recorded on the recordable medium.

14. A recordable medium as claimed in claim 12, the recordable medium further comprises a visible marking indicating the recorded search instruction.

15. A recordable medium as claimed in claim 13, wherein the visible marling comprises a text and/or image label indicating the specific type of program to be recorded.

16. A method of recording programs on a recordable medium comprising a recorded search instruction, the method comprises:
receiving receivable programs,
comparing the recorded search instruction with program information on the receivable programs to record a particular one of the receivable programs on the recordable medium only if the particular one of the receivable programs matches the recorded search instruction.

17. A method as claimed in claim 16, further comprising reading the recorded search instruction from the recordable medium, the recorded search instruction comprising an indication of a specific type of program, and wherein the program information comprises an indication of a type of the receivable programs.
